(19) United States
(12) Patent Application Publication
(10) Pub. No.: US 2020/0218967 A1
(43) Pub. Date: Jul. 9, 2020

(54) Complex-Valued Neural Networks

(71) Applicant: HEWLETT PACKARD ENTERPRISE DEVELOPMENT LP, Houston, TX (US)

(72) Inventors: John Paul Strachan, Palo Alto, CA (US); Suhas Kumar, Palo Alto, CA (US)

(21) Appl. No.: 16/371,230

(22) Filed: Apr. 1, 2019

Related U.S. Application Data
(60) Provisional application No. 62/787,823, filed on Jan. 3, 2019.

(51) Int. Cl. G06N 3/063; G06N 3/04; G06N 3/08

(52) U.S. Cl. CPC G06N 3/0635; G06N 3/08; G06N 3/04

(57) ABSTRACT

A hardware accelerator including a crossbar array programmed to calculate node values of a neural network, the crossbar array comprising a plurality of row lines, a plurality of column lines, and a memory cell coupled between each combination of one row line and one column line. Also, an energy storing element disposed in the crossbar array between each combination of one row line and one column line and a filter that receives information from the energy storing element and provides new information for each node of the neural network.

### CROSS-REFERENCE TO RELATED APPLICATIONS

This application claims the benefit of U.S. Prov. Appl. No. 62/787,723, filed Jan. 2, 2019. This application is incorporated herein by reference in its entirety to the extent consistent with the present application.

### BACKGROUND

Memristors are devices that can, be programmed to different resistive states by applying a programming energy, such as a voltage. Large crossbar arrays of memory devices with memristors can be used in a variety of applications, including memory, programmable logic, signal processing control systems, pattern recognition, and other applications.

Neural networks are a family of technical models inspired by biological nervous systems and are used to estimate or approximate functions that depend on a large number of inputs. Neural networks may be represented as systems of interconnected “neurons” which exchange messages between each other. The connections may have numeric weights that can be tuned based on experience, making neural networks adaptive to inputs and capable of machine learning.

### BRIEF DESCRIPTION OF THE DRAWINGS

FIG. 1 is a conceptual model of a neural network according to one or more examples.

FIG. 2 is a schematic representation of a hardware accelerator according to one or more examples.

FIG. 3 is a schematic representation of a hardware accelerator in accordance with one or more examples.

FIG. 4 is a pictorial representation of a crossbar array having a memory element and an energy storage element in accordance with one or more examples

FIG. 5 is a flow chart of an example process for implementing a neural network in accordance with one or more examples in accordance with one or more example embodiments.

### DETAILED DESCRIPTION

One or more examples are described in detail with reference to the accompanying figures. For consistency, like elements in the various figures are denoted by like reference numerals. In the following detailed description, specific details are set forth in order to provide a thorough understanding of the subject matter claimed below. In other instances, well-known features to one of ordinary skill in the art having the benefit of this disclosure are not described to avoid obscuring the description of the claimed subject matter.

Artificial neural networks (herein commonly referred to simply as “neural networks”), are a family of technical models inspired by biological nervous systems and are used to estimate or approximate functions that depend on a large number of inputs. Neural networks may be represented as systems of interconnected “neurons” that exchange messages between each other. The connections may have numeric weights that may be tuned based on experience, making neural networks adaptive to inputs and capable of machine learning. Neural networks may have a variety of applications, including function approximation, classification, data processing, robotics, and computer numerical control. However, implementing an artificial neural network may be very computation-intensive and may be too resource-hungry to be optimally realized with a general processor.

Memristors are devices that may be used as components in a wide range of electronic circuits, such as memories, switches, radio frequency circuits, and logic circuits and systems. In a memory structure a crossbar array of memory devices having memristors may be used. When used as a basis for memory devices, memristors may be used to store bits of information, such as 1 or 0. The resistance of a memristor may be changed by applying an electrical stimulus, such as a voltage or a current, through the memristor. Generally, at least one channel may be formed that is capable of being switched between two states—one in which the channel forms an electrically conductive path (“on”) and one in which the channel forms a less conductive path (“off”). In other cases, conductive paths represent “off” and less conductive paths represent “on”. Furthermore, memristors may also behave as an analog component with variable conductance taking on continuous rather than discrete values.

In some implementations, a memory crossbar array may be used to perform vector-matrix computations. For example, an input voltage signal from each row line of the crossbar is weighed by the conductance of the resistive devices in each column line and accumulated as the current output from each column line. Ideally, if wire resistances can be ignored, the current, I, flowing out of the crossbar array will be approximately I^{T} =V^{T} G, where V is the input voltage and G is the conductance matrix, including contributions from each memristor in the crossbar array. The use of memristors at junctions or cross-points of the crossbar array enables programming the resistance, or conductance, at each such junction.

Examples disclosed herein may provide for hardware accelerators for calculating node values for neural networks. Example hardware accelerators may include a crossbar array programmed to calculate node values. Memory cells of the crossbar array may be programmed according to a weight matrix. Driving input voltages mapped from an input vector through the crossbar array may produce output current values that may be compared to a threshold current to generate a new input vector of new node values. In this manner, example accelerators herein may provide for hardware calculations of node values for neural networks.

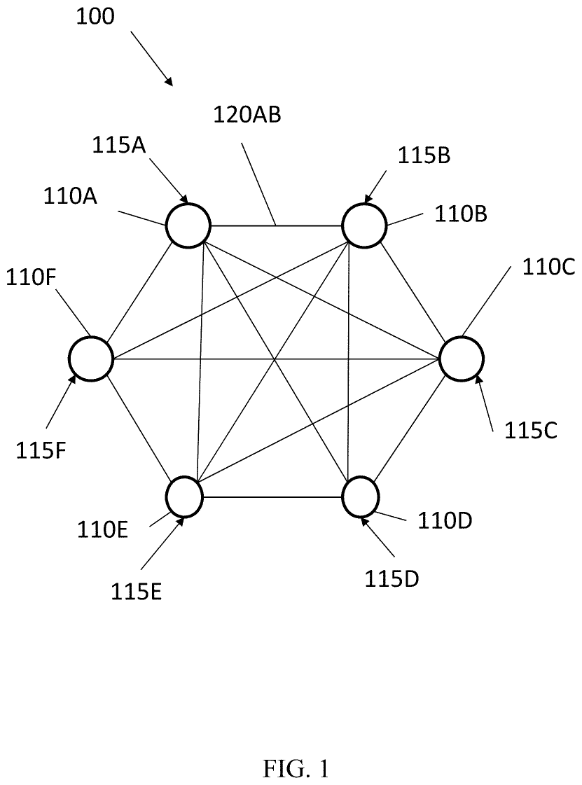

Turning to FIG. 1, a conceptual model of a neural network according to one or more examples is shown. Neural network 100 may have a number of nodes 110A-110F and edges 120. Edges 120 are formed between each node 110, but for simplicity of illustration, only the edge 120AB between 110A and 110B is labeled. A computational problem may be encoded in the weights of the edges 120 that additionally utilizes a non-linear threshold function on the edge weights to determine node updates. Input node values 115A-115F may be delivered to the nodes until the computational answer of the program is determined by a final state of the node values 115A-115F. As such, neural network 100 may be a dynamic system and the node values 115A-115F may evolve based on the edge weights to the other node values, which may be represented as a dot-product operation.

Such neural networks 100 may include technological implementations of modules inspired by biological nervous systems and may be used to estimate or approximate functions that depend on a large number of inputs. Neural networks 100 may be represented as systems of interconnected “neurons” that exchange messages between one another. The connections may have numeric weights that can be tuned based on experience, thereby making neural networks adaptive to inputs and capable of machine learning. There are various types of neural networks, including for example, feedforward neural networks, radial basis function neural networks, recurrent neural networks, as well as other types of neural networks not specifically referenced herein. Neural networks, such as a Hopfield network, may provide computational capabilities for logic optimization, analog digital conversion, encoding and decoding, and associated memories.

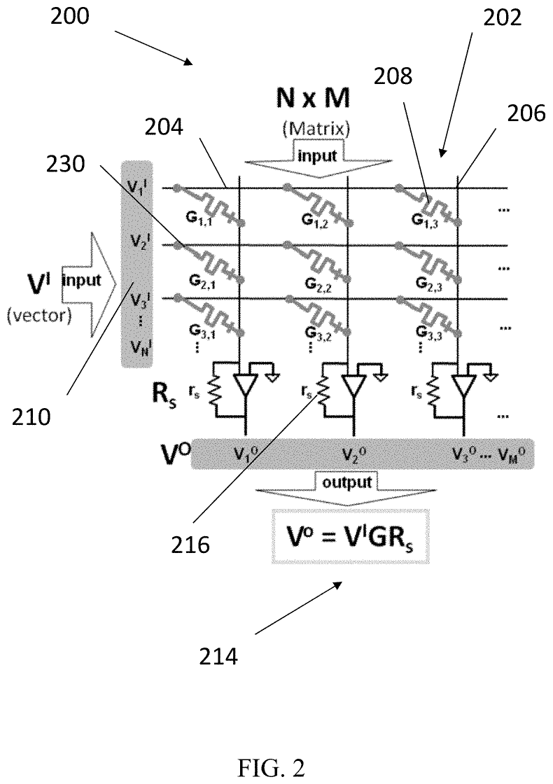

Turning to FIG. 2, a schematic representation of a hardware accelerator according to one or more examples is shown. Hardware accelerator 200 may be a hardware unit that executes an operation that calculates node values for neural networks. Hardware accelerator 200 may calculate new node values of a neural network by transforming an input vector in relation to a weight matrix. Hardware accelerator 200 may calculate such node values by calculating a vector-matrix multiplication of the input vector with the weight matrix.

Hardware accelerator 200 may be implemented as a crossbar array 202 and current comparators 216. Crossbar array 202 may be a configuration of parallel and perpendicular lines with memory cells coupled between the lines at intersections. Crossbar array 202 may include a number of row lines 204 and a number of column lines 206, as well as a number of memory cells 208. A memory cell 208 may be coupled between each unique combination of one row line 204 and one column line 206. As such, no memory cell 208 shares both a row line 204 and a column line 206.

Row lines 204 may include electrodes that carry current through crossbar array 200. In certain examples, row lines 204 may be parallel to one another and may be equally spaced relative to one another. Row lines 204 may be a top electrode or a word line. Similarly, column lines 206 may be electrodes that run nonparallel to row lines 204. Column lines 206 may be a bottom electrode or bit line. Accordingly, row lines 204 and column lines 206 may serve as electrodes that deliver voltage and current to memory cells 208. Example materials that may be used in constructing row lines 204 and column lines 206 may include conducting materials such as Pt, Ta, Hf, Zr, Al, Co, Ni, Fe, Nb, Mo, W, Cu, Ti, TiN, TaN, Ta₂N, WN₂, NbN, MoN, TiSi₂, TiSi, TisSi₃, TaSi₂, WSi₂, NbSi₂, V₃Si, electrically doped polycrystalline Si, electrically doped polycrystalline Ge, and combinations thereof. As illustrated, crossbar array 202 may include 1 . . . N row lines 204 and 1 . . . N column lines 206.

Memory cells 208 may be coupled between row lines 204 and column lines 206 at intersections of specific row lines 204 and column lines 206. For example, memory cells 208 may be positioned to calculate a new node value of an input vector of node values with respect to a weight matrix. Each memory cell 208 may have a memory device, such as a resistive memory element, a capacitive memory element, or some other form of memory.

In certain examples, each memory cell 208 may include a resistive memory element. Such resistive memory elements may have a resistance that changes with an applied voltage or current. Furthermore, in some examples, the resistive memory element may “memorize” its last resistance. In this manner, each resistive memory element may be set to at least two states. In certain examples, a resistive memory element may be set to multiple resistance states that may facilitate various analog operations. The resistive memory element may accomplish these properties by having a memristor, which may be a two-terminal electrical component that provides memristive properties as described herein.

In certain examples, a memristor may be nitride-based, indicating that at least a portion of the memristor is formed from a nitride-containing composition. A memristor may also be oxide-based, indicating that at least a portion of the memristor is formed from an oxide-containing composition. In other examples, a memristor may be oxy-nitride-based, indicating that at least a portion of the memristor is formed from an oxy-nitride-containing composition. Example materials of memristors may include tantalum oxide, hafnium oxide, titanium oxide, yttrium oxide, niobium oxide, zirconium oxide, or other similar oxides. Memristors may also include non-transitional metal oxides, such as aluminum oxide, calcium oxide, magnesium oxide, dysprosium oxide, lanthanum oxide, silicon dioxide, or other similar oxides. Further example materials may include nitrides, such as aluminum nitride, gallium nitride, tantalum nitride, silicon nitride, and oxynitrides such as silicon oxynitride.

Memristors may exhibit linear or nonlinear current-voltage behavior. Nonlinear may be described a function that grows differently than a linear function. In certain implementations, it may be linear or nonlinear in specific desired voltage ranges. The specific voltage ranges may include, for example, a range of voltages used in the operation of hardware accelerator 200.

In some examples, memory cell 208 may include other components, such as access transistors or selectors. For example, each memory cell 208 may be coupled to an access transistor between the intersections of a row line 204 and a column line 206. Access transistors may facilitate the targeting of individual or groups of memory cells 208 to read from or write specific memory cells 208.

In other implementations, a selector may be an electrical device used in memristor devices to provide desired electrical properties. For example, a selector may be a two-terminal device or circuit element that emits a current that depends on the voltage applied across the terminals. A selector may be coupled to specific memory cells 208 to facilitate the targeting of individual or groups of memory cells 208. For example, a selector may act as an on-off switch and may mitigate sneak current disturbance.

Memory cells 208 of crossbar array 202 may be programmed according to a weight matrix of a neural network. A weight matrix may represent a compilation of operations of a specific neural network. For example, a weight matrix may represent the weighted edges of neural network 100 of FIG. 1. The value stored in memory cells 208 may represent the values of a weight matrix. In implementations of resistive memory, the resistance levels of each memory cell 208 may represent a value of the weight matrix. In such a manner, the weight matrix may be mapped onto crossbar array 202.

Memory cells 208 may be programmed, for example, by having programming signals driven through them, which drives a change in the state of the memory cells 208. The programming signals may define a number of values to be applied to specific memory cells 208. As described herein, the values of memory cells 208 of crossbar array 202 may represent a weight matrix of a neural network.

Hardware accelerator 200 may receive an input vector of node values at the plurality of row lines 204. The input vector may include node values that are to be evolved into next input values for the neural network. The input vector node values may be converted to input voltages 210 by a drive circuit. The drive circuit may deliver a set of input voltages that represent the input vector to the crossbar array 202. In certain examples, the voltages 210 may be other forms of electrical stimulus, such as an electrical current driven to the memory cells 208. Furthermore, in some examples, the input vector may include digital values that may be converted to analog values of the input electrical signals by a digital-to-analog converter. In other examples, the input vector may already include analog values.

After passing through crossbar array 202, the plurality of column lines 206 may deliver output currents 214, where the output currents 214 may be compared to a threshold current according to an update rule to generate a new input vector of new node values. Details of such operations will be described below.

Hardware accelerator 200 may also include peripheral circuitry associated with crossbar array 202. For example, an address decoder may be used to select a row line 204 and activate a drive circuit corresponding to the selected row line 204. The drive circuit for a selected row line 204 can drive a corresponding row line 204 with different voltages corresponding to a neural network or the process of setting resistance values within memory cells 208 of crossbar array 202. Similar drive and decode circuitry may also be used to control the application of voltages at the inputs and reading of voltages at the outputs of hardware accelerator 200. Digital to analog circuitry and analog to digital circuity may be used for input voltages 210 and the output currents. In some examples, the peripheral circuitry above described may be fabricated using semiconductor processing techniques in the same integrated structure of semiconductor die as crossbar array 202.

There are three main operations that may occur during operation of hardware accelerator 200. The first operation is to program memory cells 208 in crossbar array 202 so as to map the mathematical values in an N×M weight matrix to the array. In some examples, N and M may be the same number and the weight matrix is symmetrical. In other examples, one memory cell 208 is programmed at a time during the programming operation. The second operation is to calculate an output current by the dot-product of input voltage and the resistance values of memory cells 208 of a column line 206. In this operation, input voltages are applied and output currents obtained corresponding to the result of multiplying an N×M matrix by an N×1 vector. In some examples, the input voltages are below the programming voltages so the resistance values of memory cells 208, such as resistive memory, are not changed during the linear transformation calculation. The third operation is to compare the output currents with a threshold current. For example, current comparators 216 may compare the output currents with the threshold current to determine a new input vector of new node values.

Hardware accelerator 200 may calculate node values by applying a net of voltages V_{I} 210 simultaneously along row lines 204 of the N×M crossbar array 202, collect the currents through column lines 206, and generate new node values 214. On each column line 206, every input voltage 210 is weighed by the corresponding memristance (1/Gᵢⱼ) and the weighted summation is reflected at the output current. Using Ohm's law, the relation between the input voltages 210 and the output currents may be represented by a vector-matrix multiplication of the form: {V⁰}T=−{V^{I}}^{T}[G] Rs, where Gₜⱼ is an N×M matrix determined by the conductance (inverse of resistance) of crossbar array 202, Rs is the resistance value of the sense amplifiers, and T denotes the transpose of the column vectors V⁰ and V^{I}. The negative sign follows from use of a negative feedback operational amplifier in the sense amplifiers. Thus, hardware accelerator 200 may be used for multiplying a first vector of values {bᵢ}T by a matrix of values [aᵢⱼ] to obtain a second vector of values [cⱼ]^{T} , where i−1,N and j=1,M. The vector operation may be set forth in more detail as follows:

$$\begin{matrix}{a}_{11} {b}_{1} + {a}_{21} {b}_{2} + … + {a}_{N 1} {b}_{N} = {c}_{1} \\ … \\ {a}_{1 M} {b}_{1} + {a}_{2} {b}_{2} + … + {a}_{NM} {b}_{N} = {c}_{M}\end{matrix}$$

The vector processing or multiplication using the principles described herein generally starts by mapping a matrix of values [aᵢⱼ] onto crossbar array 202 or, stated otherwise, programming, e.g., writing, conductance values Gᵢⱼ into the crossbar junctions of the crossbar array 202.

In some examples, each of the conductance values Gᵢⱼ may be set by sequentially imposing a voltage drop over each of the memory cells 208. For example, the conductance value G_{2,3} may be set by applying a voltage equal to V_{Row2} at the 2^{nd} row line 204 of crossbar array 202 and a voltage equal to V_{CoI3} at the 3^{rd} column line 206 of the array. The voltage input, V_{Row2,} may be applied to the 2^{nd} row line at location 230 occurring at the 2^{nd} row line adjacent the j=1 column line. The voltage input, V_{CoI3}, will be applied to the 3^{rd} column line adjacent either the i=1 or i=N location. Note that when applying a voltage at a column line 206, the sense circuitry for that column line may be switched out and a voltage driver switched in. The voltage difference V_{Row2} −V_{CoI3} will generally determine the resulting conductance value G_{2,3} based on the characteristics of the memory cell 208 located at the intersection. When following this approach, the unselected column lines 206 and row lines 204 may be addressed according to one of several schemes, including, for example, floating all unselected column lines 206 and row lines 204 or grounding all unselected column lines and row lines. Other schemes involve grounding column lines 206 or grounding partial column lines 206. Grounding all unselected column lines and row lines is beneficial in that the scheme helps to isolate the unselected column lines and row lines to minimize the sneak path currents to the selected column line 206.

In accordance with examples herein, memristors used in memory cell 208 may have linear current-voltage relations. In certain implementations, to decrease sneak path currents, additional devices, such as access transistors or non-linear selectors may also be used together with memristors. Specifically, memory cells may include various types of memristors including, for example, a resistive memory element, a memristor, a memristor and transistor, and/or a memristor and other components.

Following programming, operation of hardware accelerator 200 may proceed by applying input voltages 210 and compare the output currents to threshold currents. The output current delivered from column lines 206 may be compared, by a current comparator 216, with a threshold current. Current comparator 216 may be a circuit or device that compares two currents, i.e., an output current and a threshold current, and outputs a digital signal indicating which is larger. Current comparator 216 may have two analog input terminals and one binary digital output.

By comparing the output current with the threshold current, each current comparator 216 may determine a new node value for the neural network. The new node values may be aggregated to generate a new input vector. For example, each output current may be compared with the threshold current by an update rule. For example, a new node value corresponding to a particular output current is set to a first value if the particular output current is greater than or equal to the threshold current θᵢ. The new node value is set to a second value if the particular output current is less than the threshold current a. Each output current may be represented as the sum of the products of an input vector with the weight matrix. For example, the update rule may be represented as the equation:

$$Sj = \begin{matrix}+ 1 & if \sum {w}_{ij} {s}_{j} \geq {θ}_{i} \\ - 1 & otherwise\end{matrix}$$

The node values may also be programmed to attain values of +1 or 0, rather than +1 and −1 in the above equation. Any other pair of values may also be used. In some examples the threshold currents may be delivered to the current comparators 216 via circuitry independent from crossbar array 202. Additionally, in some examples, column lines 206 may have different threshold currents associated with it, while in other examples each column line 206 may be associated with a same threshold current.

Hardware accelerator 200 may be implemented as an engine in a computing device. Example computing devices that include an example hardware accelerator 200 may include, for example, a personal computer, a cloud server, a local area network server, a web server, a mainframe, a mobile computing device, a notebook or desktop computer, a smart TV, a point-of-sale device, or a combination of devices, such as devices connected by cloud or internet networks, that are capable of performing the functions described herein.

Neural networks, such as those implemented through hardware accelerator 200, may thereby allow for the solving of complex computational problems. In one example, such a neural network may be trained to a set of distinct patterns, and any starting input that is close to one of the patterns will auto-associate to the closest previously trained pattern. Said another way, a noisy input may be provided and result in a cleaned output. This process builds an associative memory, thereby allowing the network to learn.

As indicated above, such neural networks use real numbers, such as values 0, +1, −1, and the like, in order to capture specific functions to be minimized. However, in certain instances, optimization problems involve functions to be minimized and constraints on valid solutions. Functions may include the way a variable depends on one or more other variables. For example, a function may include minimizing/maximizing distance between two or more locations, decreasing/increasing cost as a result of multiple variables, increasing/decreasing yield as a result of a modification to a variable, increasing/decreasing energy as a result of a change to a system, and the like. Constraints may refer to a condition that a solution to a problem must satisfy, such as a limitation or requirement. Example constraints in optimization problems may include a limitation on a variable, a requirement a variable must achieve, a cost, a time, a placement, and the like. While such neural networks may be capable of solving such optimization problems, the solution may be time consuming and relatively high energy. In order to solve complex optimization problems, additional example implementations are provided below. Such additional implementations may use complex numbers, in order to provide a solution more efficiently while requiring less energy.

Used together, neural networks may be created that have increased computational power. As a result of using real numbers in binary form, as discussed above, as well as complex numbers, which may generate more than the +1 and −1 numbers, increasingly complex and powerful neural networks may be created.

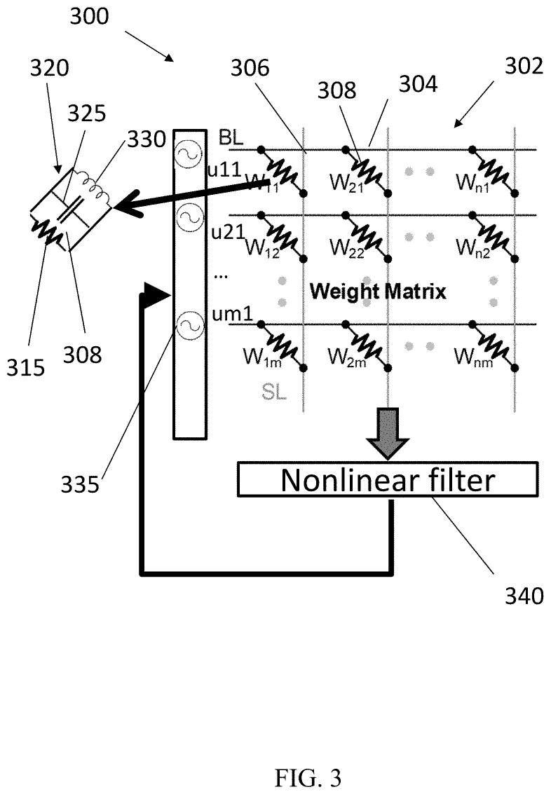

Referring to FIG. 3, a schematic representation of a hardware accelerator according to one or more examples is shown. A hardware accelerator 300 may include many similar components to those discussed above with respect to FIG. 2. Hardware accelerator 300 for a neural network may include a crossbar array 302 having a plurality of row lines 304 and a plurality of column lines 306. Crossbar array 302 may further include a plurality of memory cells 308 disposed to connect unique combinations of row lines 304 and column lines 306. In operation, hardware accelerator 300 may function as described with respect to FIG. 2 in order to determine a conductive or resistive property of memory cell 308.

In addition to memory cell 308, including a resistive component 315, such as memristor, hardware accelerator 300 may also include one or more energy storing elements 320. In certain implementations, energy storing elements 320 may be a part of memory cell 308, while in other implementations, energy storing elements 320 may be disposed separately from memory cell 308. Energy storing elements 320 may include any device capable of storing energy such as, for example, a capacitor 325, an inductor 330, a tunable memcapacitor, a tunable memductor, and/or other devices of the like. In certain implementations, multiple energy storing elements may be used, for example, both a capacitor 325 and an inductor 330 may be used. The use of multiple energy storing elements 320 may thereby allow for the generation of complex numbers, which may be used to increase efficiency of the neural network. The generation and use of such complex numbers is described in detail below.

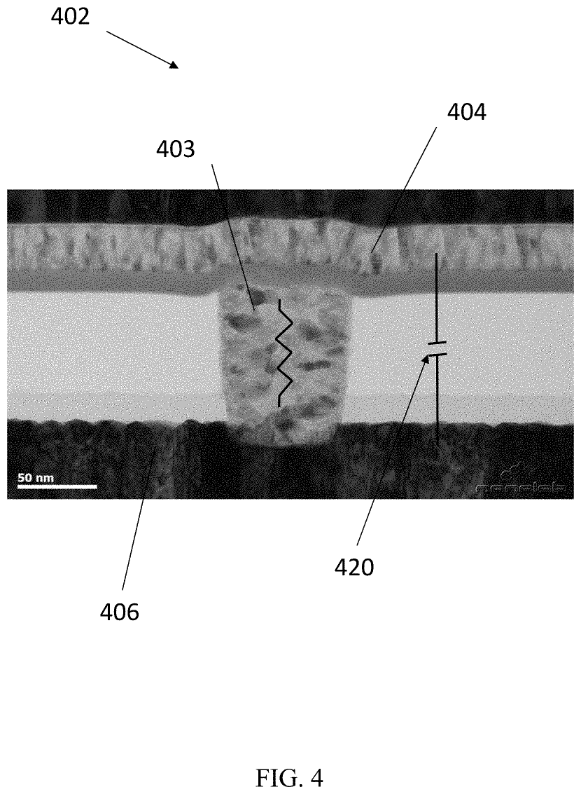

Referring briefly to FIG. 4, a pictorial depiction of a crossbar array according to one or more examples is shown. The picture is shown at a scale of 50 nanometers. In this example, crossbar array 402 have a memory device 403 that connects a horizontal row 404 and a vertical row 406. Memory device 403 may be, as explained in detail above, a memristor. Crossbar array 402 is also connected to an energy storing element 420. In this example, energy storing element 420 is a capacitor, however, other energy storing elements 420 such as those discussed above may also be used. The orientation of memory device 403 and energy storing element 420 may vary depending on the requirements of a specific neural network. In this example, memory device 403 and energy storing elements 420 are disposed in parallel, however, in other implementations, memory device 403 and energy storing elements 420 may be disposed in series.

Referring back to FIG. 3, hardware accelerator 300 may further include a voltage source 335 that is used to apply initial voltages and updated voltages as described in detail above. Hardware accelerator 300 may further include a filter 340 that is used to process information received from crossbar array 302 during operation. In this example, filter 340 is a nonlinear filter, and as such, the output of filter 340 is not a linear function of the input. In other examples, other types of filters may also be used.

In operation, hardware accelerator 300 replaces the real, e.g., binary, values provided in Hopfield Neural Networks with complex numbers in both the states and weighted connections of the neural network. Complex numbers refer to numbers that are expressed in the form of a+bi, where a and b are real numbers and i is a solution to the equation x²=−1. Accordingly, in the equation a+bi, a is called the “real part”, while bi is referred to as the “imaginary part”. The real part can capture certain aspects of processes, while the imaginary part can capture other aspects of the process.

In order to provide complex numbers, both the real parts and the imaginary parts of the complex number are determined based on the use of energy storing elements 320. Waves representative of the energy from energy storing elements 320 are represented as nodes within the neural network. As waves have both an amplitude and a phase, the nodes also have both an amplitude and a phase, such that u=Ae^{iϕ}; and u=A(cos ϕ+I sin ϕ), where u is the node. Similarly, the weighted connections can implement both an amplitude modulation and a phase change to the states following _{wij}=Wije^{iϕshift}.

During operation of neural network using complex numbers, the real numbers portion of the weights may be realized by the tunable conductance of a memory device, such as a memristor. The imaginary numbers may be realized by energy storing elements 320, such as capacitors 325 and/or inductors 330. For example, while the resistive, or real numbers portion is provided by the memory device, the reactive, imaginary numbers may be simultaneously provided by the memory device.

In order to determine the real part and the imaginary part of the complex number, the wave of an energy storage element 320 may be obtained. The amplitude and the phase of the wave may then be determined. The amplitude of the wave may be used to represent the real part, while the phase of the wave may be used to represent the imaginary part. In other examples, the phase of the wave may be used to represent the real part, while the amplitude of the wave may be used to represent the imaginary part.

Accordingly, use of complex numbers may allow certain functions to be encoded in the real part of the wave, i.e., the amplitude, while constraints may be encoded on the imaginary part of the wave, i.e., the phase. The use of reactive complex numbers along with the resistive real numbers may thereby allow information in the content of the states and the weights of neural networks to be increased. As such, complex numbers may be used instead of real numbers to increase efficiency in solving complex problems.

During operation, the crossbar array 302 may be programmed to calculate node values for a neural network, wherein the crossbar array 302 includes a memory cell 308 having a memory device, such as a memristor. Thus, the neural network may be capable of generating real numbers based on the tunability of a memristor. The neural network may further include an energy storing element 320 that is also disposed in the crossbar array 302. The energy storing element 320 may provide information in the form of a wave, from which an amplitude and a phase is determined, which may then be represented in the neural network as a node. The filter 340 may thus provide new information for processing based on the determined amplitude and phase information. The amplitude and the phase may then be used to represent, either the real part or the imaginary part of a complex number, which may then be used in both the states and weighted connections of the neural network. Accordingly, the informational content of both the states and weighted connections may be increased without adding significant cost or use of area on crossbar array 302.

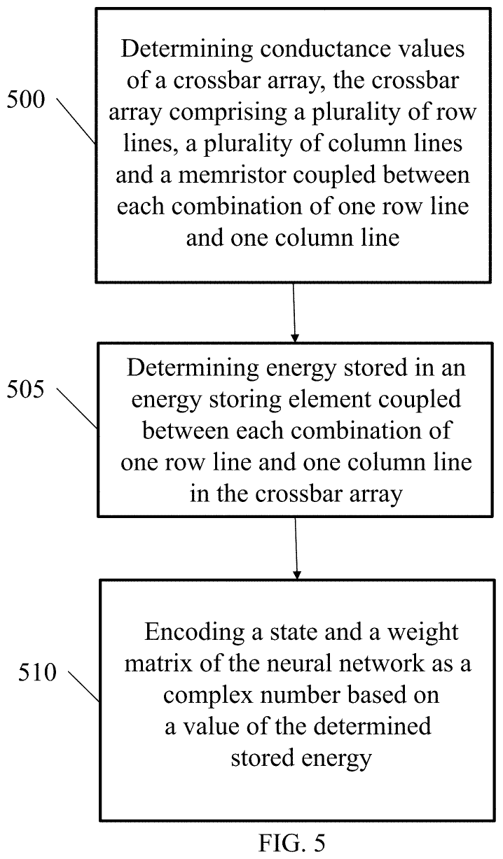

Turning to FIG. 5, a flow chart of an example process for implementing a neural network according to one or more examples is shown. Processes in accordance with such examples may generate complex numbers that may be used in providing complex values for states and weighted connections of neural networks. The complex numbers generated by such methods may be used in Hopfield Neural Networks, thereby allowing such neural networks to perform analysis of complex problems more efficiently.

In operation, such processes may include determining (500) conductance values of a crossbar array. The crossbar array may include a plurality of row lines, a plurality of column lines, and a memristor coupled between each combination of one row line and one column line. The conductance values may be used as representations of the resistive, real numbers, portion of the connecting weights of a neural network due to the tunable conductance of the memristor.

In operation, the process may also include determining (505) energy stored in an energy storing element coupled between each combination of one row line and one column line in the crossbar array. The energy stored may be used as representations of the reactive, imaginary numbers, portions that may be realized due to the capacitive and inductive properties of the energy storing elements. In certain implementations, energy storing elements may include a single energy storing element, such as a capacitor or an inductor, while in other embodiments, energy storing element may include two, three, or greater numbers of energy storing elements. The number of energy storing elements, and specific devices included therein may be adjusted based on the requirements of the neural network. For example, in neural networks requiring greater processing speed or lower energy use, a greater number of energy storing elements may be used.

In operation, the process may further include encoding (510) a state and a weight matrix of the neural network as complex numbers based on a value of the determined stored energy. The value of the determined stored energy may refer to a representation of stored energy in the form of a wave. The wave may have an amplitude and a phase. The wave may thus be filtered, as explained above, in order to determine the amplitude and the phase, and such elements may be used in generation of the complex numbers. For example, the wave may be filtered to determine that the amplitude is representative of a real part of a complex number while the phase is representative of an imaginary part of a complex number. In other examples, aspects of the conductance values may be representative of the real part while only the amplitude or the phase may be used as the imaginary part.

Parts of the complex number may also be used to capture specific variants. For example, a real part of the complex number may be used to capture a function, such as a function to be minimized. Such a function that may require minimization could include a problem having a continuous variable. In addition to minimization, a function that is captured could include functions to maximize or otherwise provide analyzation of a changing set of variable. In other examples, the imaginary part of the complex number may be used to capture a constraint to be satisfied. An exemplary constraint may include solving for binary variables.

In still other aspects, the processes disclosed herein may be used to represent nodes of the neural network as waves. In such an implementation, the waves may have an amplitude and a phase, and the value of the determined stored energy may include or otherwise be related to the wave.

In still other aspects, the process may include updating the state and the weight matrix of the neural network based on a change to at least one of the capacitance values and the energy stored. By updating the state and weight matrix, the neural network may be used to find solutions to a problem. Furthermore, because complex numbers may be used in addition to binary numbers the efficiency of the processing may be increased.

It should be appreciated that all combinations of the foregoing concepts (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

While the present teachings have been described in conjunction with various examples, it is not intended that the present teachings be limited to such examples. The above-described examples may be implemented in any of numerous ways.

Also, the technology described herein may be embodied as a method, of which at least one example has been provided. The acts performed as part of the method may be ordered in any suitable way. Accordingly, examples may be constructed in which acts are performed in an order different than illustrated, which may include performing some acts simultaneously, even though shown as sequential acts in illustrative examples.

Advantages of one or more example embodiments may include one or more of the following:

In one or more examples, systems and methods disclosed herein may be used to implement complex valued Hopfield Neural Networks with low overhead on a memory element, such as a memristor.

In one or more examples, systems and methods disclosed herein may be used to provide a scalable approach, thereby allowing for large problems to be solved, while maintaining low energy and high operating frequency.

In one or more examples, systems and methods disclosed herein may be used to increase computing capacity of neural networks by using complex weightings.

In one or more examples, systems and methods disclosed herein may be used to provide mixed optimizations to be carried out, where variables may include both real and imaginary parts.

Not all embodiments will necessarily manifest all these advantages. To the extent that various embodiments may manifest one or more of these advantages, not all of them will do so to the same degree.

While the claimed subject matter has been described with respect to the above-noted embodiments, those skilled in the art, having the benefit of this disclosure, will recognize that other embodiments may be devised that are within the scope of claims below as illustrated by the example embodiments disclosed herein. Accordingly, the scope of the protection sought should be limited only by the appended claims.

What is claimed is:

1. A hardware accelerator comprising:
a crossbar array programmed to calculate node values of a neural network, the crossbar array comprising a plurality of row lines, a plurality of column lines, and a memory cell coupled between each combination of one row line and one column line;
an energy storing element disposed in the crossbar array between each combination of one row line and one column line;
a current comparator to compare each output current to a threshold current according to an update rule to generate a new input vector of new node values; and
a filter that receives information from the energy storing element and provides new information for each node of the neural network.

2. The hardware accelerator of claim 1, wherein the energy storing element comprises a capacitive element and an inductive element.

3. The hardware accelerator of claim 1, wherein a node of the neural network represents waves, the waves comprising an amplitude and a phase.

4. The hardware accelerator of claim 1, wherein the new information comprises an amplitude of a wave related to the energy storing element.

5. The hardware accelerator of claim 1, wherein the new information comprises a phase of a wave related to the energy storing element.

6. The hardware accelerator of claim 1, wherein the memory cell comprises a memristor.

7. The hardware accelerator of claim 6, wherein the energy storing element is disposed parallel to the memristor.

8. The hardware accelerator of claim 6, wherein the energy storing element is disposed in series with the memristor.

9. The hardware accelerator of claim 1, wherein the filter is a nonlinear filter.

10. A system for implementing a neural network, the system comprising:
a plurality of row lines in a crossbar array;
a plurality of column lines in the crossbar array;
a memory device coupled between each combination of one row line and one column line of the crossbar array;
a capacitive device coupled between each combination of one row line and one column line of the crossbar array; and
an inductive device coupled between each combination of one row line and one column line of the crossbar array.

11. The system of claim 10, wherein the memory device comprises a memristor.

12. The system of claim 10, wherein the capacitive device comprises a memcapacitor.

13. The system of claim 10, wherein the inductive device comprises a memductor.

14. The system of claim 10, wherein the memory device, the capacitive device, and the inductive device are disposed in parallel.

15. A method of implementing a neural network, the method comprising:
determining conductance values of a crossbar array, the crossbar array comprising a plurality of row lines, a plurality of column lines, and a memristor coupled between each combination of one row line and one column line;
determining energy stored in an energy storing element coupled between each combination of one row line and one column line in the crossbar array; and
encoding a state and a weight matrix of the neural network as complex numbers based on a value of the determined stored energy.

16. The method of claim 15, wherein a real part of the complex number captures a function to be minimized.

17. The method of claim 15, where an imaginary part of the complex number captures a constraint to be satisfied.

18. The method of claim 15, further comprising representing nodes of the neural network as waves, wherein the waves have an amplitude and a phase, wherein the value of the determined stored energy comprises the waves.

19. The method of claim 15, wherein the energy storing element comprises a capacitive element and an inductive element.

20. The method of claim 15, further comprising updating the state and the weight matrix of the neural network based on a change to at least one of the capacitance values and the energy stored.
